(19) United States
(12) Patent Application Publication
(10) Pub. No.: US 2024/0113396 A1
(43) Pub. Date: Apr. 4, 2024

(54) Busbar assembly and vehicle battery

(71) Applicant: Webasto SE, Stockdorf (DE)

(72) Inventors: Moritz Pradella, Stockdorf (DE); Jan Woköck, Stockdorf (DE)

(21) Appl. No.: 18/372,399

(22) Filed: Sep. 25, 2023

(30) Foreign Application Priority Data
Sep. 30, 2022 (DE) 102022125431.3

(51) Int. Cl. H01M 50/505; H01M 50/222; H01M 50/264

(52) U.S. Cl. CPC H01M 50/505; H01M 50/222; H01M 50/264; H01M 2220/20

(57) ABSTRACT

A busbar assembly for a vehicle battery of an electric vehicle, comprising at least two busbars arranged side by side for electrically contacting at least one electrical component of the vehicle battery, where the busbars are surrounded by a plastics body, where at least one fastening insert for fastening the plastics body to a structure of the vehicle battery is embedded in the plastics body.

### CROSS-REFERENCE TO RELATED APPLICATION

This application claims priority to German Application No. DE 10 2022 125 431.3 filed Sep. 30, 2022, which is incorporated herein by reference in its entirety for all purposes.

### TECHNICAL FIELD

The present invention relates to a busbar assembly for installation in a vehicle battery for an electric vehicle, and to a vehicle battery for an electric vehicle.

### BACKGROUND

In the field of vehicle batteries in electric vehicles, it is known to electrically contact or connect the battery cells and battery modules with one another by means of collecting conductors, which are referred to synonymously as busbars. The busbars can be in the form of rigid current conductors of readily conductive metal, often copper, more specifically of sheet metal strips, for example of copper. Because readily conductive metals such as copper or aluminium are comparatively expensive, attempts are made to use them sparingly. Efforts are thus made, for example, to keep the cross section of the busbars used as small as possible. One criterion which stands in the way of a reduction in the cross section, more so than the electrical carrying capacity, is the development of heat in the busbars. This is because the better the dissipation of the heat that forms by friction of the electrons as the current flows, the smaller the cross section of the busbar can become. And the cooler the busbar, the lower the ohmic resistance of the busbar, which is important from the point of view of efficiency.

As part of the requirement specification of a vehicle battery, a temperature limit of below 100° C., typically about 80° C., is often given as a requirement. This temperature limit must not be exceeded during operation, for example in order to ensure the long-term operational stability of the battery assembly.

For protection against inadvertent contacting of the busbars during mounting or maintenance, and in order to shield the busbars, with the exception of the contacting regions of the busbars that are provided for contacting, with respect to the surroundings, the busbars can be received in a half-shell or two-sided busbar housing.

In order to efficiently dissipate the heat that forms as a result of the current flow in the busbar, it is known to provide so-called gap pads, for example in the form of small EPDM mats or made of silicone, and/or so-called gap fillers, for example in the form of a gel-like paste which can harden at least in part, which partially serve as a thermal bridge between the busbars and the housing. In order to ensure contact, or a planar connection, between the busbars, the gap filler or gap pad and the housing, hold-down devices, typically plastics hold-down devices, are further used.

### SUMMARY OF THE INVENTION

Starting from the known prior art, an object of the present invention is to provide an improved busbar assembly for installation in a vehicle battery for an electric vehicle, and an improved vehicle battery for an electric vehicle.

The object is achieved by a busbar assembly for installation in a vehicle battery for an electric vehicle having the features of claim 1. Advantageous developments will become apparent from the dependent claims, the description and the figures.

Accordingly, a busbar assembly for a vehicle battery of an electric vehicle is proposed, which busbar assembly comprises at least two busbars arranged side by side for electrically contacting at least one electrical component of the vehicle battery, wherein the busbars are surrounded by a plastics body. The plastics body can be a foam body. According to the invention, at least one fastening insert for fastening the plastics body to a structure of the vehicle battery is embedded in the plastics body.

By embedding a fastening insert, the rigidity of the busbar assembly can be increased further by mounting it directly to structures of the vehicle battery. Accordingly, the provision of fastening points in particular contributes towards further reducing the tendency of the busbars to vibrate.

Moreover, the line working time can thus be further reduced. This is because, by embedding fastening inserts in the plastics body, the manual insertion, positioning and fastening of further components, instead of the inserts, as is otherwise necessary, can be dispensed with.

The fastening insert can be received as an insert part in the plastics body. In this way, a fastening insert which is structurally connected to the plastics body and which is fixedly connected to the plastics body in a simple way can be provided.

At least one heat-conducting insert for dissipating heat from the plastics body can also be embedded in the plastics body. Heat which develops during operation of the battery and during operation of the busbars with a high current flow can thus be dissipated from the plastics body and can thus ensure a reduced temperature of the busbars. The predefined specifications can thus be observed, or the busbars can be provided with a reduced cross section.

The heat-conducting insert can be configured as an insert part and can be provided, for example, in the form of an insert part configured as a metal sheet. A thermally conductive connection between the plastics body and the heat-conducting insert can thus be provided in a simple way.

The plastics body can extend substantially over the entire length of the busbars. Compared to conventional vehicle batteries, in which the busbars are held loosely or only in places, the development of vibrations in the busbars can thus be substantially reduced or even avoided completely. This is because the foam material of the plastics body has a damping and stabilizing action.

In contrast to a power electronic circuit, in which the collecting conductors installed therein have only a short longitudinal extent, for example several centimetres or decimetres, the busbars in vehicle batteries for electric vehicles often extend over a large part of the length of the electric vehicle, for example with lengths in the metre range. Accordingly, the busbars, which in conventional designs are often fastened only in points, tend to vibrate during operation of the electric vehicle. These vibrations are undesirable, on the one hand because they can generate noise and on the other hand because they could damage the busbars or other components of the vehicle battery. By forming the plastics body substantially over the entire length of the busbars, the busbars can be significantly stabilized without the number of parts of the vehicle battery having to be increased and additional manufacturing steps being required.

Moreover, because the busbars are surrounded substantially completely by the plastics body, that is to say the busbars are embedded substantially completely in the plastics body, a comparatively large amount of heat can be transmitted from the busbars to the plastics body. Accordingly, the busbar assembly provides high thermal conductivity from the busbars into the plastics body and, from there, into further components of the busbar assembly and of the vehicle battery.

Consequently, the cross section of the busbars can be configured to be comparatively small, owing to the high heat dissipation, in particular when the sheathing of the busbars by the plastics body is present substantially over the entire periphery of the cross section of the busbars. Material can thus be saved in the design of the busbars compared to conventional designs in respect of the busbars.

Owing to the good electrical insulating action of the plastics body, it is possible, with a suitable design of the plastics body, in particular if the sheathing of the busbars by the plastics body is present substantially over the entire periphery of the cross section of the busbars and the busbars are surrounded by the plastics body substantially over their entire length—possibly with the exception of the contact regions, for example—to achieve a further reduction in the installation space by reducing the minimum distances between adjacent busbars without the risk of arcing increasing or even existing at all.

Furthermore, the busbar assembly and a vehicle battery comprising it can be configured with fewer components compared to conventional designs. Inter alia, owing to the provision of the plastics body, gap pads, gap fillers and hold-down devices, including the fastening screws required therefor, which are otherwise required can be dispensed with.

The reduction in the number of parts and therefore in the number of manufacturing steps required to produce the busbar assembly or the vehicle battery further results in a reduction in the line cycle time in the production of a vehicle battery.

Furthermore, because the busbars are sheathed by the plastics body, a touch-safe shield which is otherwise required around the busbars can be omitted.

The plastics body can be a foam body of a plastics material. The busbars can thus be surrounded by or moulded in the foam body particularly efficiently. This is because the busbars can be encapsulated in foam during the foaming process, so that a composite body consisting of the foam body and the busbars thereby encapsulated in foam is formed.

By encapsulating the busbars substantially completely in foam by means of the foam body, a comparatively large amount of heat can be transmitted from the busbars to the plastics body. Accordingly, the busbar assembly provides high thermal conductivity from the busbars into the foam body and, from there, into further components of the busbar assembly and of the vehicle battery.

The plastics body can comprise at least one additive or at least one filler, in particular a reinforcing material for improving the mechanical properties, for example carbon particles, carbon fibres, glass particles, glass fibres and/or basalt particles and/or basalt fibres. Alternatively or in addition, the plastics body can also comprise an additive or filler in the form of a heat conductor which has a higher thermal conductivity than the base material of the plastics material in which the additive or additives is/are embedded, for example metal particles, metal fibres (or metal chips), carbon particles or carbon fibres, in particular highly thermally conductive carbon fibres.

The additive can bring about an improvement in the mechanical properties of the plastics body, for example an increase in the modulus of elasticity and/or an increase in the damping properties, and an increase in the thermal conductivity of the plastics body compared to a plastics body formed purely of the base material or matrix material of the plastics body.

The busbars can be in the form of sheet metal strips, preferably sheet copper strips and/or sheet aluminium strips.

The plastics body can comprise an elastomer, a thermoplastic elastomer and/or a thermoplastic plastic.

The plastics body, for example the foam body, can comprise or consist of a plastics foam, preferably polyurethane foam.

The plastics body can be a resilient plastics body.

The plastics body, which is in the form of, for example, a foam body, can have a hardness of Shore A 60-100, in particular a hardness of Shore A 80-90. In this way, the plastics body can be configured to be resilient and can thus also provide vibration damping. For example, the plastics body can be arranged between a battery module and the cover of a battery housing and in this way can contribute towards the vibration damping of the cover of the battery housing.

The plastics body can have a density of from 0.5 to 1.5 kg/dm³, in particular from 0.8 to 1.2 kg/dm³, in particular when it is in the form of a foam body.

The plastics body can be moulded on, preferably injection moulded on and/or applied by foaming to, at least one housing part of a housing for receiving the busbars, preferably a lower shell and/or an upper shell.

The plastics body can also surround at least one busbar in the peripheral direction of the cross section thereof orthogonal to its longitudinal extent at least on three sides, in particular completely.

The “surrounding” of the busbars with the plastics material as described in this document can be adhesive surrounding, in which the plastics material adheres permanently to an outer surface of at least one busbar.

The term “moulded on” and “mould on”, respectively, is here defined as the adhesion of the adhesive and/or reactive plastics material to the surface of an adhesive partner, for example to the surface of the busbars and/or to a surface of a housing part, which occurs during a flowable state during moulding, for example injection moulding or casting, of the plastics body.

The term “apply by foaming” or “applied by foaming”, respectively, is here defined as the adhesion of the reactive foam material to the surface of an adhesive partner which occurs during the process of foaming a plastics foam. Accordingly, in the case of a foaming process for forming the plastics body in the form of a foam body, the foam is here permanently adhesively bonded to the inside wall as a result of the adhesive action of the reactive foam during foaming, specifically without an adhesive bonding step with an additional adhesive being carried out. There is thus no additional adhesive layer between the foam material of the foam body and the inside wall. Rather, the foam body adheres directly to the inside wall. “Application by foaming”, like “injection moulding” or “overmoulding”, therefore constitutes a form of “moulding on”.

The moulded-on surface, surrounded by the plastics material, of the joining partner of the plastics body, for example of the foam body, in particular a surface of a busbar and/or a surface of a housing part, can have been subjected beforehand to pre-treatment, for example cleaning or roughening. An adhesion promoter or an adhesion-promoting layer, in particular a primer, can be applied.

The above-mentioned object is further achieved by a vehicle battery for an electric vehicle having the features of claim 12. Advantageous developments will become apparent from the present description and the figures.

Accordingly, a vehicle battery for an electric vehicle is proposed, which vehicle battery comprises a plurality of battery units which are to be connected together, in particular a plurality of battery modules each comprising multiple battery cells, and a busbar assembly according to one of the preceding embodiments. The battery units are electrically contacted, for example, by the busbars of the busbar assembly.

The advantages and effects described in respect of the busbar assembly are achieved in an analogous manner by means of the vehicle battery.

A “vehicle battery for an electric vehicle” is here understood as being the primary drive battery of the electric vehicle, that is to say the battery that provides the (high-voltage) power for the electric motor, configured as the primary traction drive, of the electric vehicle.

### BRIEF DESCRIPTION OF THE FIGURES

Preferred further embodiments of the invention will be explained in greater detail by the following description of the figures, in which:

FIG. 1 shows, schematically, a sectional view through the busbar assembly in a vehicle battery orthogonal to a longitudinal extent of the busbar assembly;

FIG. 2 shows, schematically, a perspective sectional view through the busbar assembly of FIG. 1; and

FIG. 3 shows, schematically, a sectional view through a further busbar assembly orthogonal to a longitudinal extent of the busbar assembly.

### DETAILED DESCRIPTION OF PREFERRED EXEMPLARY EMBODIMENTS

In the following text, preferred exemplary embodiments are described with reference to the figures. Elements in the various figures which are the same, similar or have the same effect are provided with identical reference signs, and a repeat description of such elements is in some cases dispensed with, in order to avoid duplication.

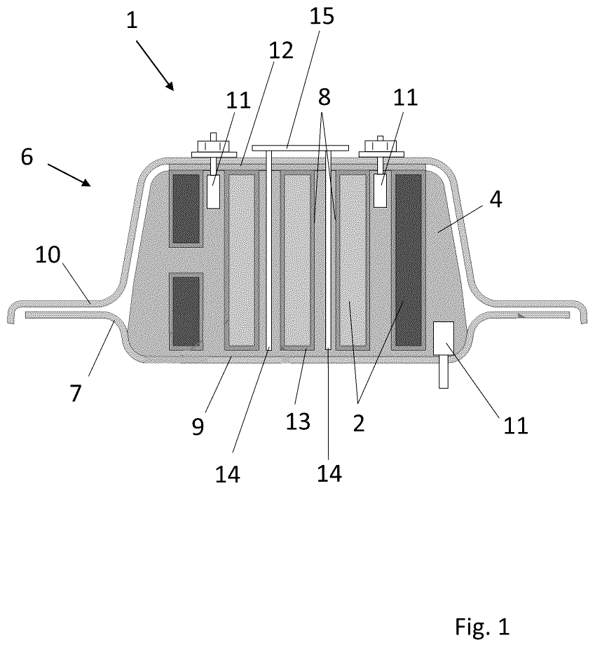

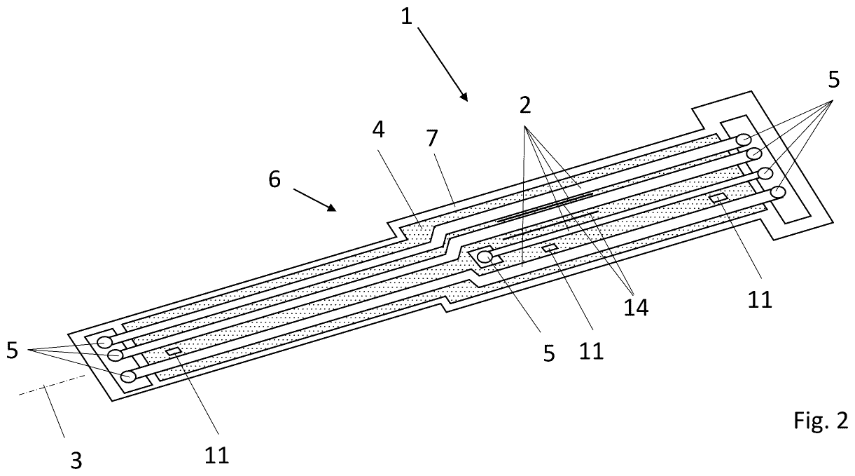

FIG. 2 shows, schematically, a perspective sectional view through part of a busbar assembly 1 in a vehicle battery. FIG. 1 shows, schematically, a sectional view through the busbar assembly 1 orthogonal to a longitudinal extent 3 of the busbar assembly 1. The sectional planes in FIGS. 1 and 2 each run through a plurality of busbars 2 arranged side by side. The busbars 2 are sheet metal strips, here sheet copper strips, with the longitudinal extent 3 thereof as the main extent. The longitudinal extent 3 corresponds substantially to a longitudinal direction of the vehicle battery and also of the electric vehicle in which the busbar assembly 1 is installed.

The busbars 2 are received substantially over their entire length in a plastics body 4, here in the form of a foam body of foamed and cured polyurethane. In other words, the busbars 2 are encapsulated in foam by the plastics body 4 substantially over their entire length. According to this embodiment, the contact regions 5 for electrical contacting of the busbars 2 are not encapsulated in foam by the plastics body 4. In an alternative embodiment, the contact regions 5 can be encapsulated at least partially in foam by the plastics body 4.

In the present embodiment, the busbars 2 have first been arranged in a predefined position relative to a lower shell 7 of a housing, more specifically of a busbar housing 6, and then encapsulated in foam by introduction of the foam material forming the plastics body 4. After it has solidified, the plastics body 4, owing to the adhesive properties of the foam material during foaming, permanently adheres to the outer surfaces 8 of the busbars 2 and to the inner side 9 of the lower shell 7.

There are further embedded in the plastics body 4 fastening inserts 11, which are provided for mounting of the busbar assembly 1 on a battery module and/or on a battery housing. These fastening inserts 11 can be encapsulated in foam by the foam material, which will later form the plastics body 4, during foaming of the plastics body 4 and in this way can become part of the busbar assembly 1. In other words, the fastening inserts 11 can be insert parts which are received in and connected to the plastics body 4 during the process of encapsulation in foam.

Alternatively, at least one fastening insert 11 can subsequently be introduced into the plastics body 4.

As is shown in FIG. 1, the fastening inserts 11 are preferably in the form of fastening points. The two fastening inserts 11 shown at the top in FIG. 1 are configured for fastening an upper shell 10 of the housing 6 to the composite body consisting of the lower shell 7 and the plastics body 4 including the busbars 2 and fastening inserts 11 embedded therein. However, they can also be configured for attachment to a cover of a battery housing.

The fastening insert 11 shown at the bottom is provided for fastening the busbar assembly 1 to a supporting structure of the vehicle battery and/or of a battery module.

The upper shell 10 is here screwed to the plastics body 4. For improved heat transmission, a gap pad 12 can be provided between the upper shell 10 and the plastics body 4.

Alternatively, the plastics body 4 can also be applied by foaming to the upper shell 10, for example instead of being applied by foaming to the lower shell 7. Or it is applied by foaming both to the lower shell 7 and to the upper shell 10.

Because the busbars 2 are substantially completely encapsulated in foam by the foam body 4, a comparatively large amount of heat can be transmitted from the busbars 2 to the plastics body 4. Accordingly, the busbar assembly 1 provides high thermal conductivity from the busbars 2 into the plastics body 4 and further into the housing 6.

Consequently, the cross section of the busbars 2 can be configured to be comparatively small, owing to the high heat dissipation, in particular if the sheathing of the busbars 2 by the plastics body 4 is present substantially over the entire periphery of the cross section of the busbars 2.

In order to improve the dissipation of heat from the plastics body 4, heat-conducting inserts 14 can further be received in the plastics body 4. For example, a heat-conducting insert 14 in the form of an aluminium sheet can be present, which permits good heat dissipation. The heat-conducting insert 14 can accordingly likewise be received in the plastics body 4 in the form of an insert part.

In the exemplary embodiment shown in FIGS. 1 and 2, two heat-conducting inserts 14 are connected together by way of a connector 15, which can improve the transmission of heat to a housing part of the battery housing or to a heat sink.

The plastics body 4 can comprise at least one additive or at least one filler, in particular a reinforcing material for improving the mechanical properties, for example carbon particles, carbon fibres, glass particles, glass fibres and/or basalt particles and/or basalt fibres. Alternatively or in addition, the plastics body can also comprise an additive or filler in the form of a heat conductor which has a higher thermal conductivity than the base material of the plastics material in which the additive or additives is/are embedded, for example metal particles, metal fibres (or metal chips), carbon particles or carbon fibres, in particular highly thermally conductive carbon fibres.

The additive can bring about an improvement in the mechanical properties of the plastics body 4, for example an increase in the modulus of elasticity and/or an increase in the damping properties, and an increase in the thermal conductivity of the plastics body 4 compared to a plastics body formed purely of the base material or matrix material of the plastics body 4.

Owing to the good electrical insulating action of the plastics body, it is possible, with a suitable design of the plastics body, in particular if the sheathing of the busbars 2 by the plastics body 4 is present substantially over the entire periphery of the cross section of the busbars 2 and the busbars 2 are surrounded by the plastics body 4 substantially over their entire length—possibly with the exception of the contact regions, for example—to achieve a further reduction in the installation space by reducing the minimum distances between adjacent busbars 2 without the risk of arcing increasing or even existing at all.

Furthermore, compared to conventional vehicle batteries, in which the busbars 2 are held loosely or only in places, the development of vibrations in the busbars 2 can be substantially reduced or even avoided completely. This is because the plastics foam of the plastics body 4 has a damping and stabilizing action.

The cured plastics foam of the plastics body 4 can have, for example, a hardness of Shore A 60-100, in particular of Shore A 80-90, and thus provides a resilient mounting for the busbars and the components of the battery that are connected by way of the fastening inserts 11.

The busbar assembly 1 can thus be provided, for example, also as a bracing and at the same time vibration damping for a cover of a battery housing. For example, the busbar assembly 1 can for this purpose be arranged between battery modules and the cover of the battery housing and thus support the cover.

Furthermore, the busbar assembly 1 and a vehicle battery comprising it can be configured with fewer components compared to conventional designs. Inter alia, owing to the provision of the plastics body 4, gap pads, gap fillers and hold-down devices, including the fastening screws required therefor, which are otherwise required can be dispensed with.

Reducing the number of parts and therefore the number of manufacturing steps required to produce the busbar assembly 1, or the vehicle battery, further results in a reduction in the line cycle time in the production of a vehicle battery.

Furthermore, owing to the sheathing of the busbars 2, a touch-safe shield 13 around the busbars which is otherwise required can also be omitted.

Foaming of the plastics body 4 can be carried out in a foaming tool (not shown here), into which the lower shell 7 and/or the upper shell 10, the busbars and the inserts 11 have correspondingly been placed before the foaming tool is closed. After it has been closed, the foam material can be introduced.

Alternatively, foaming can also take place after the busbars 2 have been inserted into the vehicle battery, preferably after the housing 6 has likewise been inserted.

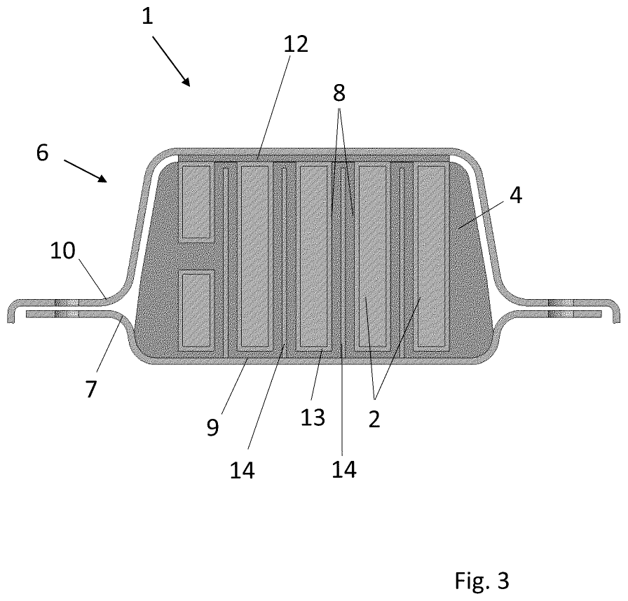

FIG. 3 shows, schematically, a sectional view through a further busbar assembly 1 orthogonal to a longitudinal extent 3 (see FIG. 2) of the busbar assembly 1. The busbar assembly 1 corresponds substantially to that of FIG. 1, wherein the heat-conducting inserts 14 are here provided inside the housing 6. Instead of the additional connector 15 of FIG. 1, the housing 6, in the present case the lower shell 7, acts as a bridge between the heat-conducting inserts 14, which are in the form of cooling fins, and as a thermal bridge for dissipating heat from the busbars 2 by way of the plastics body 4 into the heat-conducting inserts 14 and further into the housing 2 and to the surroundings outside the housing 6 and/or to components of the busbar assembly 1 and/or of a vehicle battery comprising the busbar assembly 1, which are provided for dissipating the heat from the housing 6.

Where applicable, all the individual features which are shown in the exemplary embodiments can be combined and/or exchanged with one another without departing from the scope of the invention.

### LIST OF REFERENCE SIGNS

1 Busbar assembly
2 Busbar
3 Longitudinal extent
4 Plastics body
5 Contact region
6 Housing
7 Lower shell
8 Outer surface
9 Inside wall
10 Upper shell
11 Fastening insert
12 Gap pad
13 Touch-safe shield
14 Heat-conducting insert
15 Heat-conducting insert connector

1. A busbar assembly for a vehicle battery of an electric vehicle, comprising: at least two busbars arranged side by side and configured for electrically contacting at least one electrical component of the vehicle battery, wherein the busbars are surrounded by a plastics body (4), and
at least one fastening insert configured for fastening the plastics body to a structure of the vehicle battery, wherein the at least one fastening insert is embedded in the plastics body.

2. The busbar assembly according to claim 1, wherein the plastics body comprises a foam body.

3. The busbar assembly according to claim 1, wherein the fastening insert is configured to be received as an insert part in the plastics body.

4. The busbar assembly according to claim 3, wherein at least one heat-conducting insert for dissipating heat from the plastics body configured to be embedded in the plastics body.

5. The busbar assembly according to claim 4, wherein the heat-conducting insert is configured as an insert part.

6. The busbar assembly according to claim 5, wherein the plastics body extends substantially over the entire length of the busbars.

7. The busbar assembly according to claim 6, wherein the busbars comprise sheet metal strips.

8. The busbar assembly according to claim 7, wherein the plastics body comprises a plastics foam.

9. The busbar assembly according to claim 8, wherein the plastics body has at least one of: a hardness of Shore A 60-100 a density of 0.5-1.5 kg/dm³.

10. The busbar assembly according to claim 9, wherein the plastics body is moulded on at least one housing part of a housing for receiving the busbars-.

11. The busbar assembly according to claim 10, wherein the plastics body is configured to surrounds at least one busbar in the peripheral direction of the cross section thereof orthogonal to its longitudinal extent at least on three sides.

12. A vehicle battery for an electric vehicle, comprising a plurality of battery units which are configured to be connected together, a plurality of battery modules each comprising multiple battery cells, and a busbar assembly
comprising: at least two busbars arranged side by side and configured for electrically contacting at least one electrical component of the vehicle battery, wherein the busbars are surrounded by a plastics body; and at least one fastening insert configured for fastening the plastics body to a structure of the vehicle battery, wherein the at least one fastening insert is embedded in the plastics body.

13. The busbar assembly according to claim 5, wherein the heat-conducting insert is configured in the form of an insert part configured as a metal sheet.

14. The busbar assembly according to claim 7, wherein the busbars comprise sheet copper strips.

15. The busbar assembly according to claim 7, wherein the busbars comprise sheet aluminum strips.

16. The busbar assembly according to claim 8, wherein the plastics body comprises a polyurethane foam.

17. The busbar assembly according to claim 9, wherein the plastics body has at least one of: a hardness of Shore A 80-90 and a density of 0.8-1.2 kg/dm³.

18. The busbar assembly according to claim 10, wherein the plastics body is configured by applying foaming.

19. The busbar assembly according to claim 10, wherein the plastics body is moulded on at least one of: a lower shell and an upper shell.

20. The busbar assembly according to claim 10, wherein the plastics body is configured to completely surround at least one busbar in the peripheral direction of the cross section thereof orthogonal to its longitudinal extent.
